(19) United States
(12) Patent Application Publication
(10) Pub. No.: US 2014/0088473 A1
(43) Pub. Date: Mar. 27, 2014

(54) MASSAGE DEVICE

(71) Applicant: Nicole Mastando, Braintree, MA (US)

(72) Inventor: Nicole Mastando, Braintree, MA (US)

(21) Appl. No.: 13/627,172

(22) Filed: Sep. 26, 2012

(51) Int. Cl. A61H 15/00

(52) U.S. Cl. 601/131

(57) ABSTRACT

A massage glove that overcomes the limitations and drawbacks of conventional solutions, while providing a device that is relatively inexpensive, self-contained and easy to use is disclosed. In one example, the message glove includes a glove having a palmer side, and a plurality of massaging elements disposed on the palmer side of the glove, each of the massaging elements including a socket component and a ball component configured to securely fit into the socket component.

### APPLICABLE FIELD

The field of the present invention relates generally to a massage device.

### BACKGROUND

A massage is the treatment of muscle and connective tissue with pressure to improve function, circulation, relieve pain, aid in the healing process, and promote relaxation. A popular massage method is a deep tissue massage that focuses on the muscles located below the surface of the top muscles. Deep tissue massage is often recommended for individuals who experience consistent pain, are involved in heavy physical activity and patients who have sustained physical injury.

In professional settings a deep tissue massage is administered to a client by a massage therapist. Various personal massage devices are on the market today that attempt to provide the deep-tissue massage experience at home. These devices can be hand-held or worn by one person to administer a massage to another person.

### SUMMARY

Various devices are known in the art to aid a person in providing a massage. In example includes a hand-held device comprising a handle to be held by the person administering the massage. The hand-held device also includes a base with one or more rollers that are applied to the body of the person receiving the massage. This hand-held device can provide a deep tissue massage by applying a significant amount of pressure to the body. Although, the hand-held device may be effective to massage the back, the large size associated with the hand-held device does not allow the device to be used on all parts of the body. In addition, the amount of pressure applied by the hand-held device to the body may cause painful or discomforting sensation to the person receiving the massage. Specifically, when applied to the shoulder blades or the neck the hand-held device may come in contact with bones or sensitive tissue. Furthermore, the hand-held device can be expensive and bulky making it hard to store and use for a consumer at home.

Other devices are glove massagers that fit over the hand of a person administering the massage. These glove massagers do not apply as much pressure and force to the body and can be used on all parts of the body. A typical glove massager includes either pads or protrusions in various portions of the glove. Both the pads and the protrusions are stationary and may need for the wearer to apply force to perform the massage. The force applied by the wearer may result in strained hands. Although the glove massagers may be gentler than the hand-held massagers, the glove massagers typically do not apply the necessary force needed for a deep tissue massage.

Accordingly, there is a need for a massage device that can be used to administer a deep tissue massage to every part of the body and minimizes the strain on the wearer's hands. Aspects and embodiments are directed to a massage glove device that overcomes the limitations and drawbacks of conventional solutions, while providing a device that is relatively inexpensive, self-contained and easy to use.

According to one embodiment, the massage device includes a glove. The glove may include multiple massaging elements or rollers disposed on the palmar side of the glove. The rollers may be disposed on the fingers of the glove as well as the palm of the glove. The rollers include a ball and socket design that includes a socket element and a ball element that fits within the ball element. When pressed against a person's body the rollers roll in a full rotational motion. Multiple embodiments of the ball and socket designs are disclosed herein, including socket elements forming an opening having a width smaller than the diameter of the ball, socket elements having a shape slightly larger that a hemisphere, and socket elements with rounded edges. It is appreciated that any number of combinations of rollers may be disposed in the massage glove.

According to one embodiment, a massage glove comprising a glove having a palmer side; and a plurality of massaging elements disposed on the palmer side of the glove, each of the massaging elements including a socket component and a ball component configured to securely fit into the socket component is disclosed. In one example, each of the socket components include a dome shape and each of the ball components has a spherical shape including a radius and a diameter.

In addition, each of the socket components may include a dome height and a base radius. In one example, the dome height is configured to be greater than the radius of the ball component. In another example, the radius of the ball component is configured to be greater than the base radius.

The massage glove may further include an opening formed by each of the socket components, wherein the opening includes a width smaller than the diameter of the ball component. In one example, each of the socket components has an inner side, wherein the inner side near to the opening is configured to make contact with the ball component. In another example, each of the socket components includes a flat portion disposed proximate to the glove.

In one example, each of the socket components includes an outer side, wherein the outer side has a rounded edge. In addition, each of the socket components includes a flat portion disposed proximate to the glove. In another example, each of the socket components is configured to be disposed within the glove. In yet a further example, each of the socket components is disposed outside of the glove.

In addition, the glove may include a plurality of pads disposed on the palmer side of the glove abutting each of messaging elements. In one example, each of the socket components may be disposed within the plurality of the pads. In another example, each of the socket components is disposed partially within the plurality of the pads. In a further example, the plurality of the pads includes an inner surface and an outer surface and wherein the inner surface is flat and the outer surface is convex.

Further, the massaging elements may be disposed on fingers of the glove and on a palm of the glove. In one example, the glove includes an elastic disposed around a circumference of a wrist portion of the glove. In another example, the elastic may be configured to provide a close fit around the wrist of the user.

According to another embodiment, a method of providing a massage using a massage glove, the massage glove comprising a glove having a palmer side, and a plurality of massaging elements disposed on the palmer side of the glove, each of the massaging elements including a socket component and a ball component configured to securely fit into the socket component is disclosed. In one example, the method comprises placing the glove on a hand of a user, placing the glove with the palmer side toward a person, applying pressure to the person using the ball components of the message elements.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. For purposes of clarity, not every component may be labeled in every figure. The figures are provided for the purposes of illustration and explanation and are not intended as a definition of the limits of the invention. In the figures:

FIG. 1 is a top view of one example of a massage glove, according to one embodiment;

FIG. 2A is a side view of one example of a roller, according to one embodiment;

FIG. 2B is a top view of one example of a roller, according to one embodiment;

FIG. 3A is a side view of another example of a roller, according to one embodiment;

FIG. 3B is a side view of another example of a roller, according to one embodiment;

FIG. 3C is a side view of another example of a roller, according to one embodiment;

FIG. 4A is a side view of another example of a roller, according to one embodiment;

FIG. 4B is a side view of another example of a roller, according to one embodiment;

FIG. 5 is a side view of an example of a roller disposed in a glove, according to one embodiment;

FIG. 6 is a side view of another example of a roller disposed in a glove, according to aspects of the present invention;

FIG. 7 is a side view of another example of a roller disposed in a glove, according to aspects of the present invention; and

FIG. 8 is a side view of another example of a roller disposed in a glove, according to aspects of the present invention;

### DESCRIPTION

As discussed above, conventional massage device suffers from several disadvantages, such as providing too much pressure to sensitive parts of the body, or putting strain on the user's hands. Accordingly, there is a need for a massage device that can provide a targeted, deep tissue massage without the added strain on the user's hands. Aspects and embodiments are directed to a massage glove that includes multiple massaging elements or rollers disposed on the palmar side of the glove. When pressed against a person's body the rollers roll in a full rotational motion. The added pressure from the rollers provides deep muscle tissue stimulation. The size of massaging elements and the placement of the elements on the fingers of the glove allows the wearer to selectively target muscle tissue. The rotational motion of the rollers reduces the amount of force needed to provide a deep tissue massage thereby reducing the strain on the user's fingers, hands and wrists. It is appreciated that the massage glove can be used by a massage therapist to administer a massage to a patient or can be used at home for personal use.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, and vertical and horizontal are intended for convenience of description, not to limit the present systems and methods or their components to any one positional or spatial orientation.

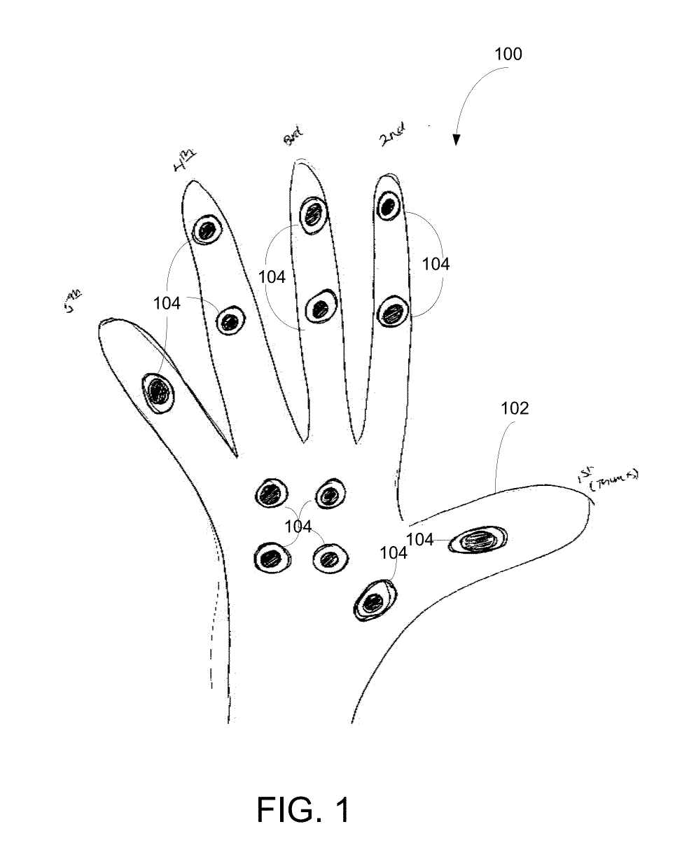

In reference to FIG. 1, there is illustrated one example of a glove massage device 100, which is worn by a user of the glove massage device to provide a massage. In the illustrated example, the glove massage device includes a glove 102, comprising five digits for fingers and including multiple massage elements or rollers 104 as further described below. The glove 102 allows the user to press the rollers 104 against a person's body causing them to rotate. The pressure of the rollers 104 combined with the motion of the user's hand allows the user to provide a targeted deep tissue massage.

The glove 102 may come in different sizes to fit different hand sizes and may be made of soft and flexible plastic material. In one example, the glove may be constructed out of a silicon material, a latex material, a cloth material such as nylon or any other material suitable for comfortable wear. In another example, the glove 102 may be made of a soft rubber material. The material may be further textured and stretchable to fit any size hands. In one example, the material may be waterproof and the glove 102 may be formed to form a waterproof seal around the hand of the user.

In various embodiments, the glove 102 may extend beyond the wrist of the wearer. To ensure a snug fit, the glove 102 may include an elastic 110 that extends around the lower portion of the glove 102 intended to be located near the wrist of the user. The elastic may be disposed within the layers of the glove. The close fit may prevent the glove from moving around the wearer's hand and allow for a more controlled massage. However, other methods of securing the glove about the wearer's hand may be used, such as draw cords or button as well as other methods.

The glove 102 has two sides, the palmar side and the dorsal side. FIG. 1 shows the palmar side of the glove. As shown in FIG. 1, the glove 102 may comprise multiple rollers disposed on the palmar portion of the glove. One or more rollers may be disposed on the fingers of the glove as well as on the palm of the glove. In the embodiment of FIG. 1, two rollers are disposed on the second, third and fourth fingers, and one roller is disposed on the first and fifth finger. Four rollers are disposed on the palm portion of the hand and a single roller is disposed in the thenar area of the thumb. It should be appreciated that any number of rollers can be arranged on the palmar side of the glove given the benefit of this disclosure.

In one embodiment, the rollers on the second, third, fourth fingers are disposed over the distal interphalangeal joints and the proximal interphalangeal joints. The rollers on the first and fifth fingers are disposed over the distal interphalangeal joint. In another embodiment, the rollers on the second, third, fourth fingers are disposed over the epidermal mounts of the fingers; the fingertips and the areas between the distal interphalangeal joints and the proximal interphalangeal joints. The rollers on the first and fifth fingers are disposed over fingertips above the distal interphalangeal joint. In one embodiment, the four rollers disposed on the palm of the hand are disposed over perimeter of the palm. For example, two of the four rollers may be disposed on the metacarpal area of the palm and two of the four rollers may be disposed on the carpal area of the palm. However, it should be appreciated that the rollers may be arranged in any number of ways given the benefits of this disclosure.

Rollers may be disposed on the dorsal side of the glove (not shown). For example, rollers may be disposed around the areas of glove near the knuckles of the hand. Roller may also be disposed throughout the back of the hand. It should be appreciated that any number of rollers can be arranged on the dorsal side of the glove given the benefit of this disclosure.

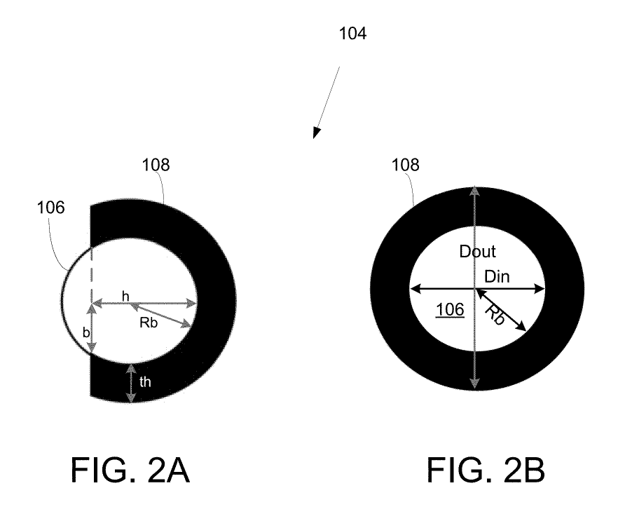

FIGS. 2A and 2B show one embodiment of the roller 104. FIG. 2A shows a side view of the roller 104 and FIG. 2B shows a top view of the roller 104, according to one embodiment. In one embodiment, the roller includes a ball element 106 106 and a socket element 108 108. The ball element 106 securely fits into the socket element 108. The socket element 108 holds the ball element 106 in place while allowing it to freely rotate in every direction. In various embodiments, the ball element 106 inside the socket element 108 has a full 360 degree freedom of rotation.

The socket element 108 has a substantially hemi-spherical shape. The socket element 108 is hollow and includes an inner portion having a diameter (Din) and an outer portion having a diameter (Dout) which may be larger than the inner diameter. The socket element may have a thickness (th). In one embodiment, the thickness may be equal throughout the socket element. In another embodiment, the thickness may vary in different portions of the socket element. In one example, the thickness may range from 2 mm to 5 mm. The ball element 106 has a spherical shape and has a radius (Rb). The rollers may come in a number of sizes to fit different hand and finger sizes. In one embodiment, the ball elements may come within two standard deviations around the average finger size. For example, the average finger width is approximately 2 cm and the ball elements may come in diameters ranging from approximately 1 cm to 3 cm.

To fit the ball element 106 and socket elements 108 together, in one example, the shape of the socket element 108 is a hollow dome including a base having a radius (b) and height of the dome (h). A dome is a portion of a sphere cut off by an intersecting plane. The height of the dome is greater than the radius of the ball element (Rb) and the base radius (b) is smaller than the radius of the ball element (Rb). The dimensions of the dome and ball element 106 are such that the ball sits securely in place in the socket element 108, but at the same time is able to freely rotate within the socket element 108.

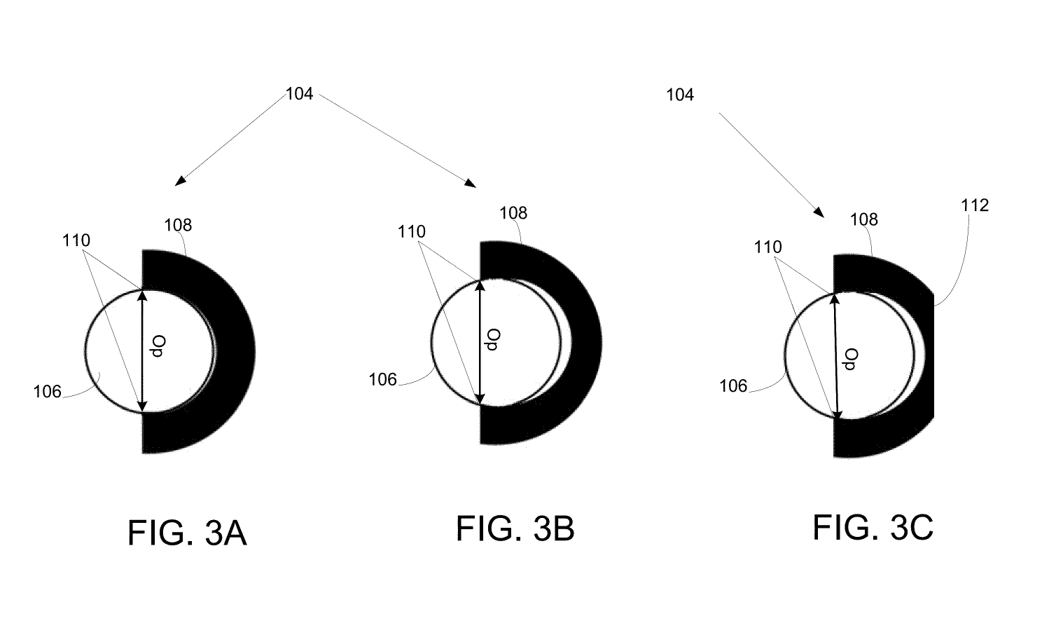

FIG. 3A shows another embodiment of a roller 104 disposed within the glove 102. In one embodiment, the shape of the socket element 108 is substantially hemispherical with an opening 110 created by the inner portion of socket element 108, such that the opening 110 has a width (Op) smaller than the diameter of the ball element 106. In this fashion the ball is held in place around the area of the opening and rotates around the area of contact.

FIG. 3B shows another embodiment of the ball element 106 and the socket element 108 having an opening 110. The ball element 106 may be shifted from the socket element 108 such that a larger surface area of the ball element 106 is outside the socket element 108 than within it. While the ball element 106 rotates within the socket element 108, the amount of contact between the ball element 106 and the socket element 108 may be reduced, thereby reducing the amount of friction created between the ball element 106 and the socket element 108. Reduced friction results in less wear and tear on the ball elements 106 which may lead to longer life and necessitates fewer replacements.

FIG. 3C shows another embodiment of the roller. In this embodiment, the socket element has a flat feature 112 on the side of the socket that is proximate to the glove. The flat feature 112 may create a larger surface area that comes in contact with the glove. The larger surface area may create a better connection to the glove. In at least one example, the edges of the flat feature 112 may be rounded (not shown).

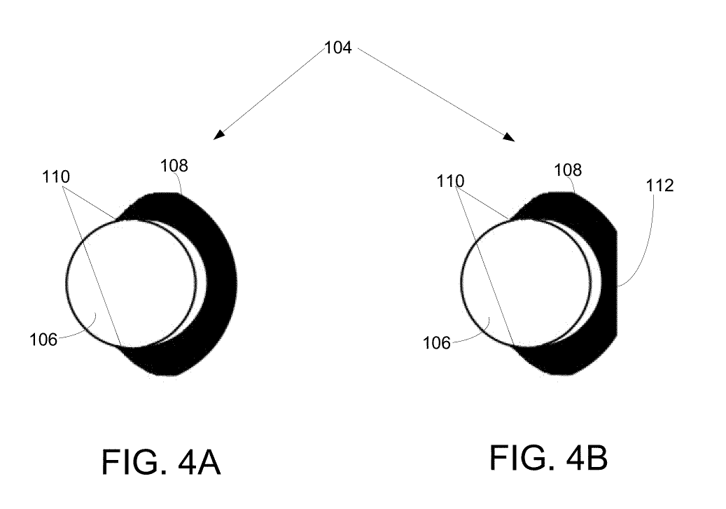

FIG. 4A shows another embodiment of a roller 104. In this embodiment, the socket element 108 has rounded edges near the opening of the socket element 108. Similar to FIG. 3A, the width of the opening of the socket element 108 is smaller than the diameter of the ball element 106. The ball element 106 is held in place by inner edges of the socket element 108. In addition, the rounded edges may reduce the possibility of contact between the socket element 108 and the person receiving the massage. In the embodiments where the socket element 108 is disposed within a pad, the pad may more easily fit around the socket element 108. FIG. 4B shows another embodiment of the roller 104. In this embodiment, the socket element 108 has a flat feature 112 on the side of the socket that is proximate to the glove 102. In at least one example, the edges of the flat feature may be rounded (not shown).

The ball elements 106 may be composed of various hard plastic composites that do not yield when pressed by the user. The socket elements 108 may be composed of various plastic composites, in some examples the plastic may be a flexible material. The rollers 102 may attach to the outer layer of the glove through the use of an adhesive. In at least one example, the rollers and the glove may be ultrasonically welded together.

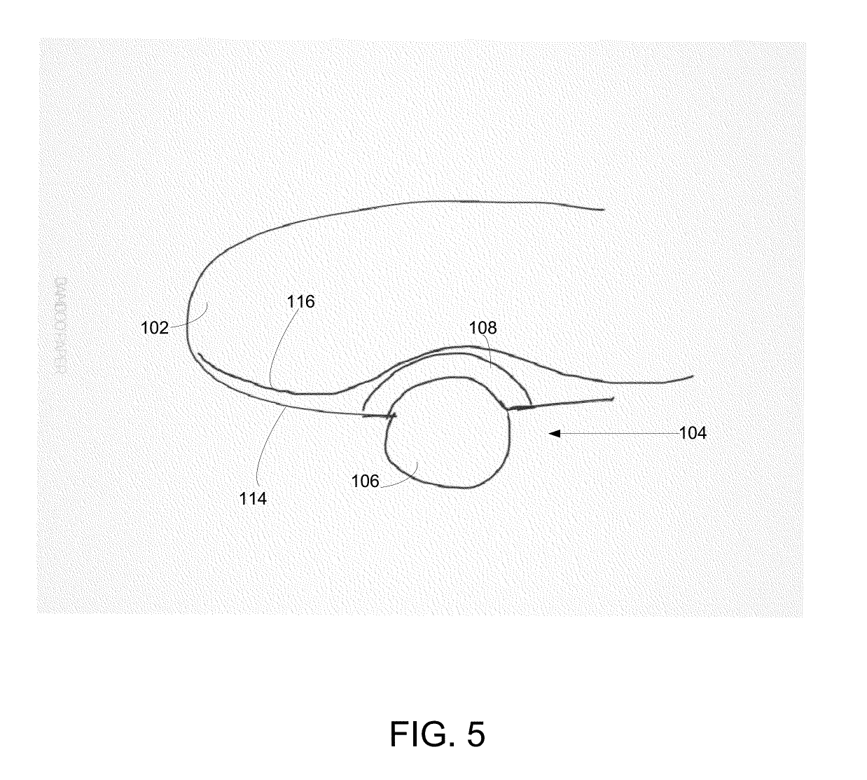

FIG. 5A shows one example of a roller 104 disposed within the glove 102. In one example, the entire socket element 108 is disposed within the glove 102, so that only the ball element 106 protrudes from the glove. In various embodiments, the glove 102 may include one or more layers of material. In one example, the glove includes two layers of material, an outer layer 114 and an inner layer 116. The outer layer 114 and the inner layer 116 may be made of the same material or the layer may be made of different materials having different properties of durability and flexibility. In one example, the layers 114 and 116 may be bonded together in all areas except where the inner layer 116 surrounds the socket element 108.

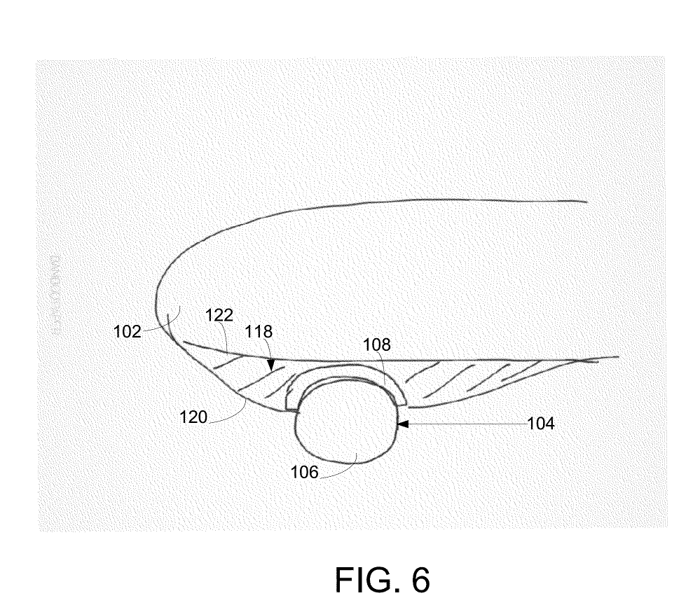

In one embodiment, the glove 102 may further include a plurality of pads 118 disposed between the socket element 108 and the glove 102. The pads 118 may cushion the finger of the user against pressure from the socket element 108, allowing the user's fingers to be more comfortable and feel less strain. FIGS. 6-8 show various embodiment of the pad 118 including the ball element 106, and the socket element 108. As shown in FIG. 6, in one embodiment, the pad 118 may enclose the socket element 108 so that the socket element is disposed within the pad 118 and only the ball element 106 protrudes from the glove 102. The pad 118 may have an outer side 120 having a convex shape extending away from the glove and an inner side 122 having a concave shape. The inner side may be shaped to conform to the shape of the hand within the glove 102, for example the finger, the palm or the knuckle.

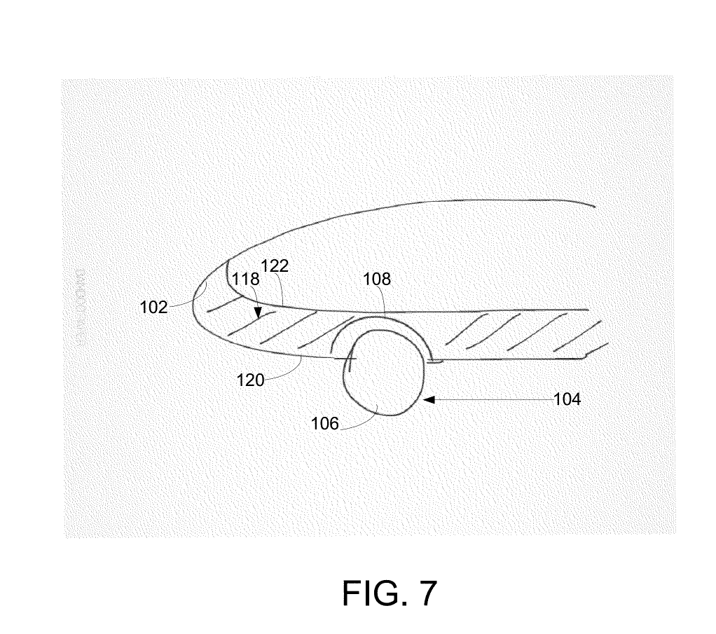

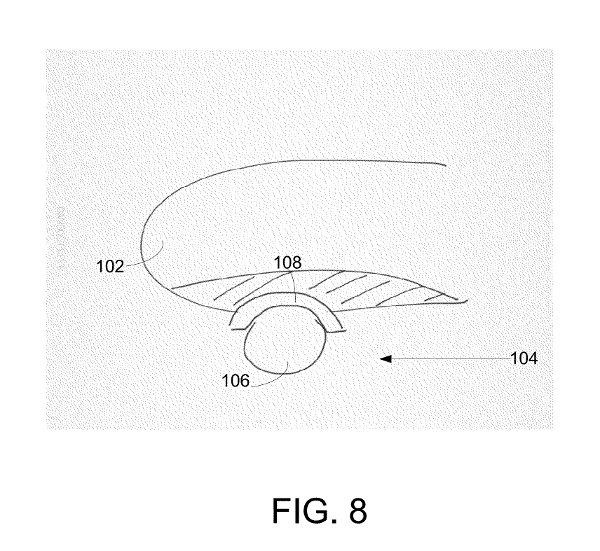

As shown in FIG. 7, in another embodiment, the pad 118 may create an extra layer within the glove. In one example, the pad may have inner 122 and the outer sides 120 of the pad substantially parallel to each other. The pad 118 may enclose the socket element 108 so that the socket element is disposed within the pad 118 and only the ball element 106 protrudes from the glove. As shown in FIG. 8, in yet another embodiment, the socket element 108 may be partially disposed within the pad 118. The pad 118 may be similar to FIG. 6, as shown. Alternatively, the pad 118 may be similar to the pad 118 in FIG. 7.

It may be desirable to clean or replace the ball elements 106. In one embodiment, a mechanism may be provided that allows the ball elements 106 to be removed from the socket elements 108. In one example, the mechanism may allow the user to pry the socket element 108 to one side so that the opening of the socket element 108 is extended beyond the diameter of the ball element 106. In one embodiment, the rollers may be removed from the glove and other attachments may be inserted. The socket element 108 may further include a cavity that can allow for the attachment to be inserted.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of apparatus components or elements, it should be understood that those elements may be combined in other ways to accomplish the same objectives. Aspects, elements and features discussed only in connection with one embodiment are not intended to be excluded from a similar role in other embodiments.

What is claimed is:

1. A massage glove comprising:
a glove having a palmer side; and
a plurality of massaging elements disposed on the palmer side of the glove, each of the massaging elements including:
a socket component; and
a ball component configured to securely fit into the socket component.

2. The massage glove of claim 1, wherein each of the socket components includes a dome shape and each of the ball components has a spherical shape including a radius and a diameter.

3. The massage glove of claim 2, wherein each of the socket components include a dome height and a base radius.

4. The massage glove of claim 3, wherein the dome height is configured to be greater than the radius of the ball component.

5. The massage glove of claim 3, wherein the radius of the ball component is configured to be greater than the base radius.

6. The massage glove of claim 2, further including an opening formed by each of the socket components, wherein the opening includes a width smaller than the diameter of the ball component.

7. The massage glove of claim 6, wherein each of the socket components has an inner side, wherein the inner side near to the opening is configured to make contact with the ball component.

8. The massage glove of claim 6, wherein each of the socket components includes a flat portion disposed proximate to the glove.

9. The massage glove of claim 2, wherein each of the socket components includes an outer side, wherein the outer side has a rounded edge.

10. The massage glove of claim 9, wherein each of the socket components includes a flat portion disposed proximate to the glove.

11. The massage glove of claim 2, wherein each of the socket components is configured to be disposed within the glove.

12. The massage glove of claim 1, wherein each of the socket components is disposed outside of the glove.

13. The massage glove of claim 1, wherein the glove includes a plurality of pads disposed on the palmer side of the glove abutting each of messaging elements.

14. The massage glove of claim 13, wherein each of the socket components is disposed within the plurality of the pads.

15. The massage glove of claim 13, wherein each of the socket components is disposed partially within the plurality of the pads.

16. The massage glove of claim 13, wherein the plurality of the pads includes an inner surface and an outer surface and wherein the inner surface is flat and the outer surface is convex.

17. The massage glove of claim 1, wherein the massaging elements are disposed on fingers of the glove and on a palm of the glove.

18. The massage glove of claim 1, wherein the glove includes an elastic disposed around a circumference of a wrist portion of the glove.

19. The massage glove of claim 18, wherein the elastic is configured to provide a close fit around the wrist of the user.

20. A method of providing a massage using a massage glove, the massage glove comprising a glove having a palmer side, and a plurality of massaging elements disposed on the palmer side of the glove, each of the massaging elements including a socket component and a ball component configured to securely fit into the socket component, the method comprising:
placing the glove on a hand of a user;
placing the glove with the palmer side toward a person;
applying pressure to the person using the ball components of the message elements.
